(19) United States
(12) Patent Application Publication
(10) Pub. No.: US 2006/0078376 A1
(43) Pub. Date: Apr. 13, 2006

(54) Shock-absorbing seat post of a bicycle with a gap adjustment mechanism

(75) Inventor: Jim Liao, Hsin Chu Hsien (TW)

Correspondence Address: TROXELL LAW OFFICE PLLC, SUITE 1404, 5205 LEESBURG PIKE, FALLS CHURCH, VA, 22041, US

(73) Assignee: Hsin Lung Accessories Co., Ltd.

(21) Appl. No.: 10/959,189

(22) Filed: Oct. 7, 2004

(51) Int. Cl. B25G 3/00

(52) U.S. Cl. 403/378

(57) ABSTRACT

A gap mechanism for a bicycle seat post comprises an outer tube having a hollow portion, an inner tube inserted into the hollow portion, and an intermediate (cushioning) sleeve disposed in the inner wall of the top portion of the outer tube and between the inner tube and outer tube, for clamping the inner tube, the intermediate sleeve being of a polygonal shape wherein the surface of a side thereof is provided with a stop member of a rigid material, thereby a bolt is provided, the end of the bolt abutting against said stop member so that the sides of the intermediate sleeve press tightly against the inner wall of the outer tube.

### BACKGROUND OF THE INVENTION

1. Field of the Invention

The present invention relates to a bicycle seat post, in particular to a gap adjustment mechanism that is capable of conveniently and effectively adjusting the gap in a bicycle seat post.

2. Description of the Related Art

Referring to FIG. 1, a schematic drawing of a conventional bicycle seat post is shown. The seat post 1 generally includes an inner tube 2, an outer tube 3 and an intermediate sleeve 4 providing cushioning effect. The inner tube 2 has a top end to which a seat 5 is attached, and a bottom end inserted in the interior of the outer tube 3. The intermediate sleeve 4 is disposed in the interior of the outer tube 3 adjacent the opening of the outer tube 3, for receiving the inner tube 2 and preventing the inner tube 2 from directly contacting the outer tube 3. When a rider rides the bicycle, the seat 5 onto which a rider sits will move up and down, which causes the inner tube 2 to transmit the motion to the intermediate sleeve 4 to also move up and down slightly. With the passing of time, the surface of the intermediate sleeve 4 will be abraded such that a gap will be produced between the intermediate sleeve 4 and the outer tube 3, and this causes the inner tube 2 to sway or wobble when the bicycle is being ridden.

### SUMMARY OF THE INVENTION

Accordingly, an object of the present invention is to provide a gap adjustment mechanism for the seat post of a bicycle, which directly abuts and presses against the intermediate sleeve so that the act and effect of adjusting the gap become more direct.

To realize the above object, the present invention provides a gap mechanism for a bicycle seat post which comprises an outer tube having a hollow portion, an inner tube inserted into the hollow portion, and an intermediate (cushioning) sleeve disposed in the inner wall of the top portion of the outer tube and between the inner tube and outer tube, for clamping the inner tube, the intermediate sleeve being of a polygonal shape wherein the surface of a side thereof is provided with a stop member of a rigid material thereby a bolt is provided, the end of the bolt abutting against said stop member so that the sides of the intermediate sleeve press tightly against the inner wall of the outer tube.

### BRIEF DESCRIPTION OF THE DRAWINGS

Other features and advantages of the present invention will become apparent in the following detailed description of the preferred embodiment with reference to the accompanying drawings, in which:

FIG. 1 shows the structure of a conventional shock-absorbing seat post of a bicycle;

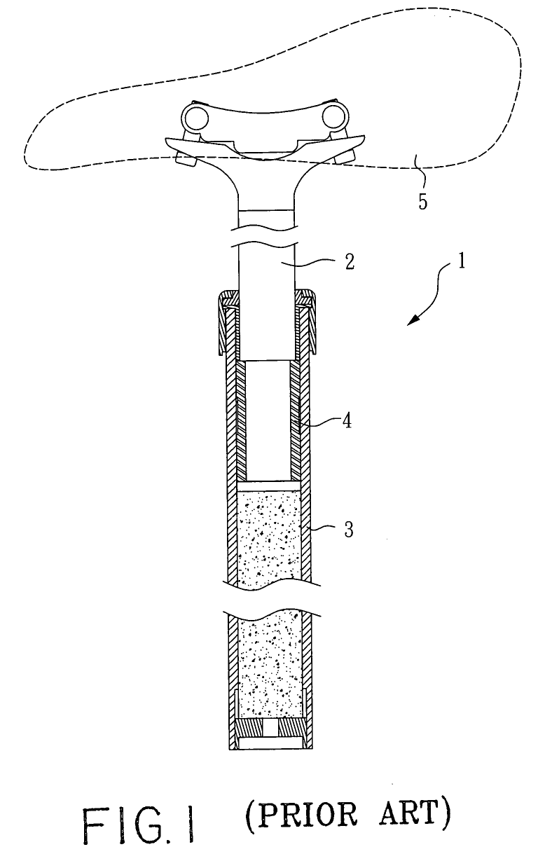

FIG. 2 is an exploded view of the present invention; and

FIG. 3 is a sectional view of the present invention.

### DETAILED DESCRIPTION OF THE PREFERRED EMBODIMENT

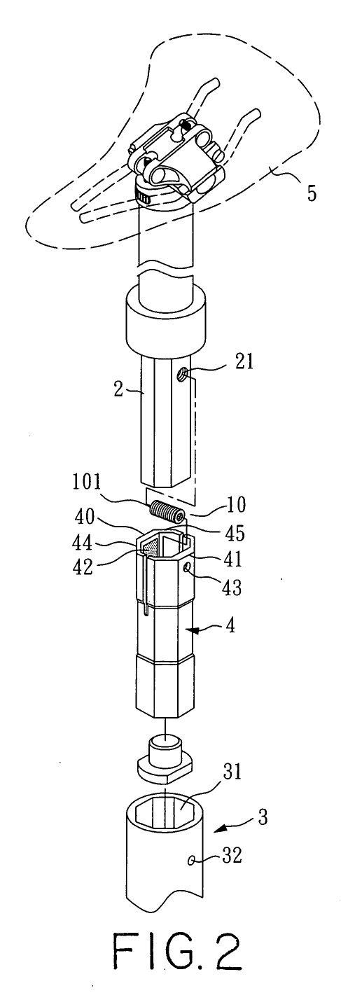

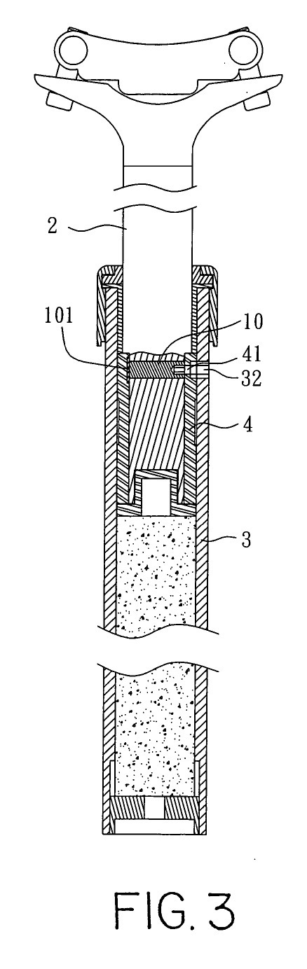

With reference to FIG. 2 in conjunction with FIG. 3, a preferred embodiment of the present invention is shown to comprise an outer tube 3 having a hollow portion 31, an inner tube 2 inserted into the hollow portion 31, and an intermediate (cushioning) sleeve 4 disposed on the inner wall of the top portion of the outer tube 3 for clamping the inner tube 2. This is the structure of generally known shock-absorbing seat posts of bicycle and does not constitute a feature of the present invention. The feature of the present invention resides in that a transverse threaded hole 21 is provided where the inner tube 2 contacts the intermediate sleeve 4, and a through hole 32 is provided on the outer tube 3 opposite to the threaded hole 21 such that the threaded hole 21 and the through-hole 32 are in alignment. The intermediate sleeve 4 is of a polygonal shape (and may be four-sided, pentagonal or hexagonal, etc. depending on the shape of the inner tube 2 and outer tube 3). The surface of a side 40 of the intermediate sleeve 4 is provided with a stop member 42 of rigid material (such as iron), and the side 41 opposite to the surface is provided with a through-hole 43 which is in alignment with the through-hole 32 of the outer tube 3. The present invention further includes a bolt 10 screwed into threaded hole 21 of the inner tube 2. A tool (not shown) rotates and screws the bolt 10 through the through hole 32 of the outer tube 3 and the through-hole 43 of the intermediate sleeve 4, so that the end 101 of the bolt 10 abuts against the stop member 42. The side 40 of the intermediate sleeve 4 tightly presses against the inner wall of the outer tube 3 and at the same time affects the sides 44,45 adjacent to the side 40 so that they too tightly press against the inner wall of the outer tube 3, and consequently, the gap between the intermediate sleeve 4 and the outer tube 3 is reduced. In time, the intermediate sleeve 4 will be abraded as a matter of course and the gap between the intermediate sleeve 4 and the outer tube 3 will thus widens. The widened gap may be eliminated simply by using a tool to rotate the bolt 10.

The gap adjustment mechanism for a bicycle seat post provided in the present invention can directly press against the intermediate sleeve, so that the act and effect of adjusting the gap is more direct.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A shock-absorbing seat post of a bicycle with a gap adjustment mechanism, comprising:
an outer tube having a hollow portion;
an inner tube disposed in said hollow portion; and
an intermediate sleeve provided on the inner wall of the top portion of said outer tube and between said inner tube and said outer tube, for clamping said inner tube,
characterized in that a transverse threaded hole is provided where said inner tube contacts said intermediate sleeve, and a through-hole is provided on said outer tube opposite to and in alignment with said threaded hole, and in that said intermediate sleeve is of a polygonal shape wherein the surface of a side thereof is provided with a stop member of a rigid material, and another side thereof opposite to said surface is provided with a through-hole which is in alignment with said through-hole of said outer tube, thereby a bolt screwed into said threaded hole of said inner tube is provided, said bolt being adjusted with a tool via said through holes so that the sides of said intermediate sleeve press tightly against the inner wall of said outer tube.

2. A shock-absorbing seat post of a bicycle with a gap adjustment mechanism according to claim 1, wherein the material of said stop member is preferably iron.
